(19) United States
(12) Patent Application Publication
(10) Pub. No.: US 2014/0266959 A1
(43) Pub. Date: Sep. 18, 2014

(54) PATCH ANTENNA

(71) Applicant: CITY UNIVERSITY OF HONG KONG, Hong Kong (HK)

(72) Inventors: Quan XUE, Hong Kong (HK); Juhua LIU, Guangzhou City (CN)

(73) Assignee: CITY UNIVERSITY OF HONG KONG, Hong Kong (HK)

(21) Appl. No.: 13/838,683

(22) Filed: Mar. 15, 2013

(51) Int. Cl. H01Q 1/48; H01Q 1/38

(52) U.S. Cl. CPC H01Q 1/48; H01Q 1/38
USPC 343/848

(57) ABSTRACT

A patch antenna is disclosed as comprising a circular patch and a circular ground plane. The patch and the ground plane are spaced apart from each other by a substrate made of a dielectric material, with the antenna being shorted concentrically by a certain number of conductive vias.

### TECHNICAL FIELD

This invention relates to a patch antenna, in particular a patch antenna suitable (but not exclusively) for use in telecommunications.

### BACKGROUND OF THE INVENTION

Monopole antennae are widely used in telecommunications. However, conventional monopole antennae usually have a high profile of quarter wavelengths, which is too high for some devices or applications that only have a limited space for housing an antenna.

It is thus an object of the present invention to provide a patch antenna in which the aforesaid shortcoming is mitigated or at least to provide a useful alternative to the trade and public.

### SUMMARY OF THE INVENTION

According to the present invention, there is provided a patch antenna comprising:

a patch, and a ground plane, wherein said patch and said ground plane are spaced apart from each other by a substrate made of a dielectric material, and wherein said antenna is shorted substantially concentrically by a plurality of conductive vias.

### BRIEF DESCRIPTION OF THE DRAWINGS

A patch antenna according to a preferred embodiment of the present invention will now be described, by way of example only, with reference to the accompanying drawings, in which:

FIG. 1A shows a front view of a microstrip monopolar patch antenna according to a preferred embodiment of the present invention;

FIG. 1B shows a cross-sectional side view of the patch antenna in FIG. 1A;

FIG. 2 shows measured results for the reflection coefficient (S₁₁) of the antenna shown in FIGS. 1A and 1B;

FIG. 3 shows simulated and measured results for the maximum gains of the antenna shown in FIGS. 1A and 1B;

FIG. 4 shows simulated and measured results for the elevation patterns of the antenna shown in FIGS. 1A and 1B at 2.15 GHz; and

FIG. 5 shows simulated and measured results for the azimuth patterns of the antenna shown in FIGS. 1A and 1B at 2.15 GHz.

### DETAILED DESCRIPTION OF A PREFERRED EMBODIMENT

A low-profile and broadband microstrip monopolar patch antenna according to a preferred embodiment of the present invention is shown in FIGS. 1A and 1B, and generally designated as 10. Briefly stated, the antenna 10 is constructed on a microstrip circular patch antenna with shorting-vias.

As shown in FIGS. 1A and 1B, the antenna 10 includes a circular ground plane 12 and a circular patch 14 which are parallel to each other, and spaced apart from each other by and engaged with a planar substrate 16 made of a dielectric material. For example, the substrate 16 may be a printed circuit board (PCB). A number of electrically conductive vias 18 are formed which extend through the ground plane 12, the circular patch 14 and the substrate 16, and electrically connect the ground plane 12 and the circular patch 14, thus shorting the antenna 10. For example, the vias 18 may be made of copper wires. The antenna 10 is fed at its centre by a 50Ω coaxial transmission line 20.

As a preferred embodiment, the radius R of the circular patch 14 is 48 mm, and the radius R_{g} of the ground plane 12 is 90 mm. The substrate 16 has a thickness h of 3.17 mm and a dielectric constant (∈ᵣ) of 2.33. Nineteen vias 18 (of which only twelve are shown in FIG. 1A) are concentrically and equi-angularly disposed with respect to a center 22 of the antenna 10. Each via 18 has a diameter of 1 mm, and the distance a between the centre 22 of the antenna 10 and the respective centre of the vias is 33.25 mm.

The antenna 10 can provide a fractional bandwidth of 18%. Measured results for the reflection coefficient (S₁₁) for the antenna 10 are shown in FIG. 2. It can be seen that the antenna 10 works in the frequency band from 2.06 GHz to 2.46 GHz, with a mean (center) working frequency of 2.26 GHz. The thickness h of the substrate 10 is thus only about 0.024 wavelengths with respect to the mean frequency of 2.26 GHz.

The maximum gain of the type of antenna 10 according to the present invention is about 6 dBi. Simulated and measured results for the maximum gains are shown in FIG. 3, in which “HFSS” means “High Frequency Structural Simulator”, and is a commercial finite element method solver for electromagnetic structures, which may be used for antenna design.

The antenna 10 according to this invention produces a vertical polarization in the horizontal plane, as does conventional monopole antennae. The antenna 10 produces a monopole-like radiation pattern. In particular, the radiation pattern in the main elevation plane has a conical shape which is similar to that produced by a monopole antenna. Simulated (HFSS) and measured results for the elevation patterns of the antenna 10 are shown in FIG. 4. The azimuth pattern in the horizontal plane of the antenna 10 is omnidirectional. Simulated (HFSS) and measured results for the azimuth patterns of the antenna 10 are shown in FIG. 5. The radiation patterns are stable in the band of interest.

While the antenna 10 provides an omnidirectional pattern and a vertical polarization in the horizontal plane, as what a conventional monopole antenna also does, compared with the conventional monopole antennae, the antenna 10 according to the present invention has a much lower profile and also provides a wide bandwidth. It has a low cost, low weight, and a simple structure that can be easily fabricated on a printed circuit board (PCB). This antenna 10 can be used in indoor base stations, vehicles, airplanes, helicopters, and the like.

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. A patch antenna comprising:
a patch, and
a ground plane,
wherein said patch and said ground plane are spaced apart from each other by a substrate made of a dielectric material, and
wherein said antenna is shorted substantially concentrically by a plurality of conductive vias.

2. The patch antenna according to claim 1 wherein said patch and said ground plane are substantially circular.

3. The patch antenna according to claim 1 wherein said conductive vias are substantially concentrically and substantially equi-angularly disposed with respect to a centre of said antenna.

4. The patch antenna according to claim 1 wherein said antenna is shorted by nineteen conductive vias.

5. The patch antenna according to claim 1 wherein said antenna is fed at its centre by a 50Ω coaxial transmission line.

6. The patch antenna according to claim 1 wherein said antenna is adapted to work in a band from substantially 2.06 GHz to substantially 2.46 GHz.

7. The patch antenna according to claim 1 wherein the thickness of said substrate is about 0.024 wavelengths with respect to the mean of its working frequency.

8. The patch antenna according to claim 7 wherein the thickness of said substrate is substantially 3.17 mm.

9. The patch antenna according to claim 1 wherein said substrate has a dielectric constant of substantially 2.33.
